(19) United States
(12) Patent Application Publication
(10) Pub. No.: US 2025/0335554 A1
(43) Pub. Date: Oct. 30, 2025

(54) METHOD FOR TRACING AGRICULTURAL PRODUCT BASED ON META-UNIVERSE

(71) Applicant: XIHUA UNIVERSITY, Chengdu (CN)

(72) Inventors: Zhicai LIU, Chengdu (CN); Xu FENG, Chengdu (CN); Ling XIONG, Chengdu (CN); Qin FU, Chengdu (CN); Xiaoluo FU, Chengdu (CN); Jiale WU, Chengdu (CN); Xianhua NIU, Chengdu (CN)

(21) Appl. No.: 18/555,535

(22) PCT Filed: Oct. 12, 2023
(86) PCT No.: PCT/CN2023/124277

§ 371 Date: Nov. 25, 2024

(30) Foreign Application Priority Data
Mar. 10, 2023 (CN) 2023102301182

(51) Int. Cl. G06F 21/16; G06Q 40/04; G06Q 50/02

(52) U.S. Cl. CPC G06F 21/16; G06Q 40/055; G06Q 50/02

(57) ABSTRACT

A method for tracing an agricultural product based on meta-universe, including the following steps: collecting, by a terminal data collecting apparatus, agricultural product data, and generating an uplinking application; verifying the legitimacy and authenticity of the uplinking application when the uplinking application is received by a blockchain network, and uplinking the uplinking application; verifying the uplinked agricultural product data, triggering a growth function of the agricultural product in a smart contract using the agricultural product data, a virtual agricultural product of a meta-universe visualization platform starting to grow; selling the agricultural product on a trading platform, and generating, by a blockchain network, a traceability code after a consumer purchases the agricultural product; verifying the legitimacy of identities and data of the meta-universe visualization platform and the consumer. The present method can retrieve data, and recover the data.

### CROSS-REFERENCE TO RELATED APPLICATIONS

This application is a national phase application of International Pat. Appl. No. PCT/CN2023/124277, filed on Oct. 12, 2023, which claims the benefit of Chinese Pat. Appl. No. 2023102301182, filed on Mar. 10, 2023, both of which are incorporated herein by reference as if fully set forth herein.

### TECHNICAL FIELD

The present invention relates to the field of meta-universe digital technology, and particularly to a method for tracing an agricultural product based on meta-universe.

### BACKGROUND

In the context of the era of “Internet+”, people have never stopped exploring a digital space. Since the concept of meta-universe has been put forward, the concept of meta-universe has triggered a wide range of attention from various industries. “meta-universe” is not a new technology per se, but integrates a large number of existing technologies, including 5G, cloud computing, artificial intelligence, virtual reality, blockchain, the Internet of Things, human-computer interaction, and so on. In the field of traditional agriculture, the sale of agricultural products is a problem that has plagued farmers for many years. Due to the lack of stable sales channels, there are often scenes of crops rotted in the ground.

An existing patent with authorization announcement No. CN115063210B, titled “METHOD FOR MATCHING INTELLIGENTLY RESOURCES BASED ON META-UNIVERSE AND META-UNIVERSE SYSTEM ( [symbol] [symbol] [symbol] )”, discloses digitizing data related to an agricultural product through digitized technology, so as to move data related to the agricultural product from offline to online. Therefore, information related to the agricultural product can be viewed by a demand side through the online. The efficiency of the interaction between a plurality of parties such as a demand side, a provider, and the like is improved, so as to enhance the demand side's access to the required resources.

However, there is often a serious discrepancy between a real thing and a photo, which is due to the fact that some agricultural product producers take advantage of the trust of a consumer and thus deceive the consumer by substituting a bad agricultural product for a good one. The traditional way for tracing the agricultural product is relatively simple. Most of the applied technologies are mainly based on the Internet of Things (IoT) technology. A generated two-dimensional code is used for traceability. But there is a drawback herein that traceability information is centrally stored in one place, which results in two threats: one is that data cannot be retrieved after being lost, and the other is that the data cannot be recovered after being tampered. In addition, there are a large number of participants in a supply chain of agricultural products and less information exchanged to each other, which lead to a reduction in the accuracy and authenticity of the traceability of the agricultural product.

Driven by real needs and the prospect of building the feasibility of the meta-universe, it is particularly important to apply blockchain technology to establish an effective method for tracing an agricultural product.

### SUMMARY

An objective of the present invention is to apply blockchain technology to establish an effective method for tracing an agricultural product, to solve the problem of not being able to retrieve data after the data are lost and the problem of not being able to recover the data after the data are tampered, and to provide an effective method for tracing an agricultural product based on meta-universe.

To realize the above objective of the present invention, an embodiment of the present invention provide the following technical solution:

A method for tracing an agricultural product based on meta-universe includes the following steps:
Step 1, an initialization phase of a system, generating, by a trusted node, system parameters, and generating, by a trusted third party, a node secret key;
Step 2, an uplinking phase of data, collecting, by a terminal data collecting apparatus, agricultural product data in one period T, and generating an uplinking application; when a blockchain network receives the uplinking application, verifying the legitimacy and authenticity of the uplinking application, and completing uplinking after it is verified that there is no error;
Step 3, a phase of growth of a virtual agricultural product and circulation of the agricultural product, verifying uplinked agricultural product data, triggering a growth function of the agricultural product in a smart contract using the agricultural product data after the verification is successful, a virtual agricultural product of a meta-universe visualization platform starting to grow, and updating a circulation trajectory of the agricultural product after the agricultural product grows to mature;
Step 4, a trading phase of the agricultural product, selling the agricultural product on a trading platform, generating, by the blockchain network, a traceability code after a consumer purchases the agricultural product successfully, pasting, by an agricultural product producer, the traceability code, and mailing the agricultural product to the consumer;
Step 5, a phase of traceability of the agricultural product, verifying legitimacy of identities and data of the meta-universe visualization platform and the consumer, and then determining a permission to open up a traceability process of the meta-universe visualization platform for viewing based on verified results.

Compared with the prior art, the present invention has the beneficial effects:
(1) System reliability: In the present invention, blockchain technology is used to store information. The blockchain technology has the characteristics of unmodifiable and distributed information, which ensures the integrity and availability of the data. Even if the data are lost, the data can be recovered through backup information of other nodes in a blockchain.
(2) Protection for user privacy: In a framework of the present invention, a commitment mechanism with homomorphic properties is used to protect transaction information. The ciphertext of a transaction amount based on the strong binding and a homomorphic addition property of a discrete logarithmic difficult problem is stored in the blockchain network, which protects the user's privacy, prevents the agricultural product producer from projecting a user's favorite preference and the profit of a farmer or the agricultural product producer through the information of the user's purchase of the product, and avoids the emergence of problems such as a false advertisement, “price discrimination”, malicious competition, and so on. In addition, a dynamic pseudonym is used to protect consumer privacy and avoid leakage of consumer identity information in the process of trading agricultural products.
(3) Non-repudiation: In the present invention, digital signature technology is adopted to sign an application or an order when confirming the right and transaction of the agricultural product, thereby avoiding malicious use and the repudiation behavior of a malicious merchant, and guaranteeing the non-repudiation of the data.
(4) Traceability: In the present invention, a trusted third party is used to generate a key for each node. Each node retains a public key certificate in the trusted node. When there is a problem in the traceability process, a node can be traced with the public key certificate to find a problematic node.
(5) Message integrity: In the present invention, a hash chain is utilized to realize the integrity of a message. Because the message is transmitted in a safe channel, it is not possible to forge a legitimate hash value. If a message TrackMsg is modified in the safe channel, the hash value is changed accordingly.
(6) Digital signature: When the terminal data collecting apparatus collects and processes the collected data and puts forward the uplinking application, a digital signature algorithm is utilized in the present invention to sign the uplinking application on the blockchain network to ensure the legitimacy and authenticity of the uplinking application.
(7) Key exchange: In a process of traceability of the agricultural product, a key exchange algorithm is used to obtain one shared key Key. The message is encrypted using the shared key Key, which not only plays a role of protection, but also realizes two-way authentication between the meta-universe visualization platform and the consumer.

### BRIEF DESCRIPTION OF THE DRAWINGS

In order to more clearly describe the technical solutions of embodiments of the present invention, the following briefly introduce the drawings that need to be used in the embodiments of the present invention. It should be understood that the following drawings only show certain embodiments of the present invention and should not be regarded as a limitation of the scope. The person skilled in the art can obtain other related drawings based on these drawings without creative work.

FIG. 1 shows a schematic diagram of a framework of the present invention;

FIG. 2 shows a flowchart of a method of the present invention.

### DETAILED DESCRIPTION

The following clearly and completely describes the technical solutions in embodiments of the present invention in conjunction with the drawings in the embodiments of the present invention. Obviously, the described embodiments are only a part the embodiments of the present invention, rather than all embodiments. The components of the embodiments of the present invention generally described and illustrated in the drawings herein can be arranged and designed in various different configurations. Therefore, the following detailed description of the embodiments of the present invention provided in the drawings is not intended to limit the scope of the claimed invention, but merely represents selected embodiments of the present invention. Based on the embodiments of the present invention, all other embodiments obtained by the person skilled in the art without inventive work shall fall within the scope of protection of the present invention.

It should be noted that similar reference numerals and letters indicate similar items in the following drawings. Therefore, once a certain item is defined in one drawing, the item does not need to be further defined and explained in the subsequent drawings. In addition, in the description of the present invention, the terms “first”, “second” and so on are only used to distinguish the description, and cannot be understood as indicating or implying relative importance or to imply the existence of any such actual relationship or order between these entities or operations. In addition, the terms “interconnected”, “connected”, etc. may be a direct connection between elements or an indirect connection via other elements.

### Embodiment 1

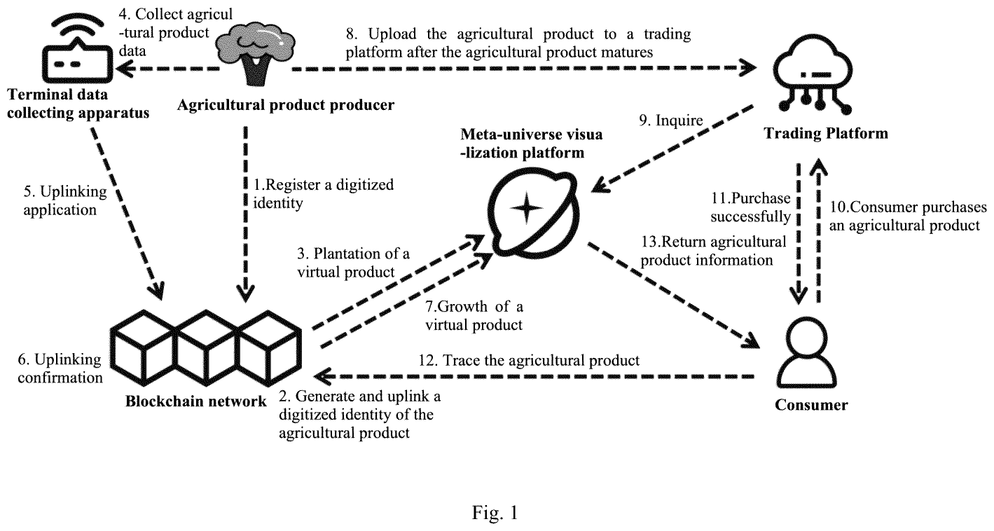

The present invention is realized by the following technical solution, which is applied in a scenario based on meta-universe as shown in FIG. 1 and includes:

An agricultural product producer APⱼ is used to produce the agricultural product. APⱼ denotes the j-th agricultural product producer (1≤j≤m). There are a total of m agricultural product producers in the scenario. If it is assumed that any agricultural product producer APⱼ can produce a total of K agricultural products, IDjk denotes the digitized identity of the k-th agricultural product produced by the agricultural product producer APⱼ (1≤k≤K).

A terminal data collecting apparatus Sf is configured to collect agricultural product data Di (1≤i≤t) produced by the agricultural product producer APⱼ. Dᵢ denotes the agricultural product data collected by the terminal data collecting apparatus Sf at an i-th moment, with a total of t moments. Sf denotes the f-th terminal data collecting apparatus (1≤f≤F). There are a total of F terminal data collecting apparatuses in the scenario. However, one agricultural product producer APⱼ may use at least one terminal data collecting apparatus, e.g., the three terminal data collecting apparatuses are used to collect the three agricultural product data produced by the agricultural product producer APⱼ.

The blockchain network is configured to uplink the data and provide a consumer P with the traceability of the product.

A meta-universe visualization platform is configured to produce a virtual agricultural product.

A trading platform is configured to provide the consumer P with a platform for purchasing the agricultural product.

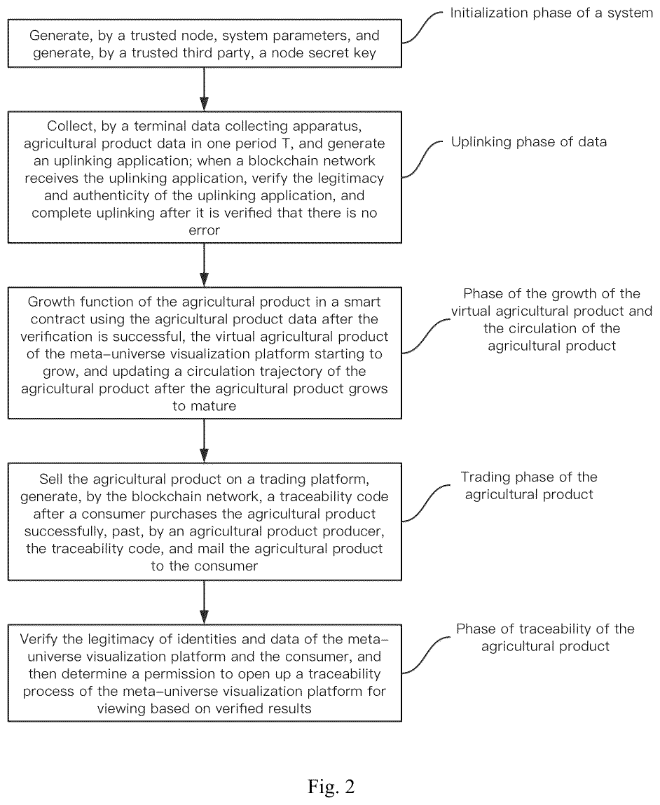

As shown in FIG. 2, the present invention proposes a method for tracing an agricultural product based on meta-universe, including the following steps:

Step 1, an initialization phase of a system, generating, by a trusted node, system parameters, and generating, by a trusted third party, a node secret key.

The trusted node selects one q-order multiplicative cyclic group G, and two generators v and p of the multiplicative cyclic group G. The trusted node selects one hash function H:{0,1}*→{0,1}¹, where 1 is the number of bits output by H, and H converts an input binary string with an arbitrary length into an output binary string with a fixed length.

The trusted node selects a public key encryption algorithm E_{PK}(·) and a private key decryption algorithm D_{SK}(·). The trusted node generates and publicizes the system parameters {G,q,v,q,H,E_{PK}(·),D_{SK}(·)}. The public key encryption algorithm E_{PK}(·) is configured to generate a public key PK. The private key decryption algorithm D_{SK}(·) is configured to generate a private key SK;

Step 2, an uplinking phase of data, collecting, by a terminal data collecting apparatus, agricultural product data in one period T, and generating an uplinking application; when a blockchain network receives the uplinking application, verifying the legitimacy and authenticity of the uplinking application, and completing uplinking after it is verified that there is no error.

It is assumed that the terminal data collecting apparatus Sf collects the agricultural product data in a period T, where f denotes a f-th terminal data collecting apparatus (f=1, 2, . . . , F). The f-th terminal data collecting apparatus is configured to collect the agricultural product data from a j-th agricultural product producer APⱼ in the period T (j=1, 2, . . . , M), that is, agricultural product information. t agricultural product data may be collected sequentially in the period T, which are D₁, D₂, . . . , Dₜ, (t agricultural product data belong to agricultural product information). The roots of the t agricultural product data are generated by a hash chain. A root of the hash chain is uplinked. Let an initial value ho of the hash chain be 0.

When the terminal data collecting apparatus Sf collects the agricultural product data Dᵢ, i=1, 2, . . . , t, the hash chain hᵢ=H(hᵢ₋₁∥Dᵢ) is calculated. Meta-information {Dᵢ,hᵢ} is sent to a cloud server through a safe channel. When the period T is cut-off, the terminal data collecting apparatus Sf obtains the root hₜ of the hash chain.

If the agricultural product producer does not register a digitized identity in the blockchain network, the agricultural product producer APjⱼ sends a registered digitized identity application ReqInfo=(σⱼ∥PKⱼ∥CheckInfo∥TS) to the blockchain network, where CheckInfo is an agricultural product related detection certificate, a brand certificate and other information. PKⱼ is a public key of the agricultural product producer APⱼ. SKⱼ is a private key of the agricultural product producer APⱼ. σⱼ is the signature of the agricultural product producer APⱼ on the registered digitized identity application ReqInfo using the private key SKⱼ. TS is a current timestamp, and ∥ is a connection character.

After receiving the registered digitized identity application ReqInfo, the blockchain network first checks the freshness of the current timestamp TS. If TS is expired, the blockchain network rejects the registered digitized identity application ReqInfo. Otherwise, an issuing node verifies the signature σⱼ using the public key PKⱼ and checks CheckInfo information. After verification passes, the issuing node applies a signature σⱼₖ to k-th agricultural product related information of the agricultural product producer Apⱼ (k=1, 2, . . . , K). The registered digitized identity application ReqInfo is mapped as a result H (ReqInfo) with a fixed digit number using a hash function H. The result is used as the digitized identity of the k-th agricultural product of the agricultural product producer APⱼ; i.e., the agricultural product digitized identity IDⱼₖ=H (ReqInfo).

The issuing node uploads the agricultural product digitized identity IDⱼₖ, the signature σⱼₖ, and CheckInfo information to the blockchain network, the agricultural product digitalized identity IDⱼₖ is uplinked through the consensus of the blockchain network to obtain a blockchain network transaction number FIDⱼₖ. Finally, the issuing node sends the agricultural product digitized identity IDⱼₖ, the signature σⱼₖ, and the blockchain network transaction number FIDⱼₖ to the agricultural product producer APⱼ and other information.

The terminal data collecting apparatus Sf calculates a signature σ_{f}=Sign(SK_{f}∥ID_{f}∥IDⱼₖ∥hₜ∥TS′), and then sends the uplinking application (SK_{f}∥ID_{f}∥IDⱼₖ∥hₜ∥TS′∥σ_{f}) to the blockchain network, where ID_{f} is a digitized identity of the terminal data collecting apparatus S_{f}. SK_{f} is a private key of the terminal data collecting apparatus S_{f}. TS′ is a current timestamp.

After receiving the uplinking application (SK_{f}∥ID_{f}∥IDⱼₖ∥hₜ∥TS′∥σ_{f}), the blockchain network first checks whether the timestamp TS′ exceeds stipulated legal time. If so, uplinking application of the terminal data collecting apparatus S_{f} is rejected. Otherwise, a public key certificate corresponding to ID_{f} is retrieved from a blockchain node. If the public key certificate does not exist, the uplinking application of the terminal data collecting apparatus S_{f} is rejected. If the public key certificate exists, the blockchain network verifies the signature σ_{f} using the public key PK_{f} in the public key certificate. PK_{f} is the public key of the terminal data collecting apparatus S_{f}. If the verification fails, the uplinking application of the terminal data collecting apparatus S_{f} is rejected. Otherwise, the blockchain network uplinks transaction information (ID_{f}∥IDⱼₖ∥hₜ∥TS′∥σ_{f}). That is, a virtual agricultural product may be planted in the meta-universe visualisation platform.

Step 3, a phase of growth of the virtual agricultural product and circulation of the agricultural product, verifying uplinked agricultural product data, triggering a growth function of the agricultural product in a smart contract using the agricultural product data after the verification is successful, the virtual agricultural product of the meta-universe visualization platform starting to grow, and updating a circulation trajectory of the agricultural product after the agricultural product grows to mature.

The meta-universe visualization platform is also a node of the blockchain network. After a root hₜ of a hash chain of the agricultural product data Dᵢ is successfully uplinked, the blockchain network sends the digitized identity IDⱼₖ of the agricultural product to the meta-universe visualization platform. The meta-universe visualization platform obtains the agricultural product data D₁, D₂, . . . , Dₜ and a value of the corresponding hash chain from the cloud server based on the digitized identity IDⱼₖ of the agricultural product. It should be noted that before the uplinking in step 2, a unique digitized identity IDⱼₖ of the agricultural product (uniqueness is guaranteed by ReqInfo) is generated. During uplinking, IDⱼₖ is used as a primary key for storing data in the cloud server to store D₁, D₂, . . . , Dₜ. When the blockchain network sends IDⱼₖ to the meta-universe visualization platform, D₁, D₂, . . . , Dₜ are obtained from the cloud server with IDⱼₖ.

After receiving the produce data Dᵢ from the cloud server, the meta-universe visualization platform calculates the value hᵢ=H(hᵢ₋₁∥Dᵢ) of the hash chain. After calculating for t times, the meta-universe visualization platform obtains the root hₜ of the recalculated hash chain. Then, the meta-universe visualization platform removes the root hₜ of the originally uplinked hash chain from the blockchain network. If the hₜ is not equal to the hₜ, an error message that the data have an error is sent to the cloud server. The uplinked product data fails to verify. the growth information of a virtual product for this time is rejected. Otherwise, the growth information of a virtual product for this time is updated.

After the uplinked product data is successfully verified, the meta-universe visualization platform updates the current growing status of the virtual product using D₁, D₂, . . . , Dₜ. An updating algorithm of a growing status is as follows:

```
(1) input: D[t], curState[t]
(2) Output: newState[t]
(3) Algorithm description:
  for i←1 to t do
    isSuccess←UpdateState(D[i],curState[i],newState[i])
    if isSuccess = False then
      Panic(i)
    end if
  end for
  return newState
```

(4) Variable explanation: D is growth information of the collected virtual agricultural product. curState is the current growth state of the virtual agricultural product. newState is the new growth state of the virtual agricultural product. UpdateState is configured to update the growth state of the virtual agricultural product. Panic is configured to report the updating abnormality of a certain growth state of the meta-universe visualization platform.

When the product is matured and circulated, the root of the hash chain is calculated and verified using the same approach for the collected data and then updated into the circulation trajectory.

Step 4, a trading phase of the agricultural product, selling the agricultural product on a trading platform, generating, by the blockchain network, a traceability code after a consumer purchases the agricultural product successfully, pasting, by an agricultural product producer, the traceability code, and mailing the agricultural product to the consumer.

To protect the privacy of a consumer and the rights and interests of the agricultural product producer, in this solution, a dynamic anonymity and a commitment mechanism with homomorphic properties are used to protect transaction information. The ciphertext of the transaction amount based on the strong binding and the homomorphic addition property of the discrete logarithmic difficult problem is stored in the blockchain network.

The consumer P selects and purchases the agricultural product on the trading platform. It is assumed that the consumer P purchases the n agricultural products from the agricultural product producer, n≤m. After the consumer P selects the agricultural product, the n random numbers that satisfy

$${\sum }_{j = 1}^{n} {r}_{j} = 0$$

are randomly selected to generate a commitment value about a purchase amount. rⱼ is the random number of the j-th agricultural product producer APⱼ. Regarding the j-th agricultural product producer APⱼ, the consumer P calculates the commitment value Cⱼ=g^{r}^{ⱼ}h^{r}^{ⱼ}, where sⱼ is the amount of money consumed by the consumer P at the agricultural product producer Apⱼ. g^{r}^{ⱼ} is used by the consumer P to commit that the amount of money declared to be purchased from the j-th agricultural product producer is correct. When a certain malicious consumer gives a large part of the amount sⱼ of money consumed to one agricultural product producer, and a very small part of the money to the other agricultural product producers, although the total amount is not changed, other agricultural products producers do not receive the corresponding amount. Therefore, the rights and interests receive great damage. So, the commitment of the consumer P is needed; h^{r}^{ⱼ} is used to hide the consumption amount sⱼ of the consumer P at the agricultural product producer APⱼ, to avoid the malicious consumer to learn or even tamper. Then, the consumer P encrypts rⱼ using the public key PKⱼ to obtain the transaction amount ciphertext Rⱼ=E_{PK}_{ⱼ}(rⱼ∥sⱼ), where E_{PK}_{ⱼ}(·) is a public key encryption algorithm. a transaction uplinking application (PID∥C₁∥ . . . ∥Cₙ∥R₁∥ . . . ∥Rₙ∥S) is sent to the blockchain network, where PID is a dynamic pseudonym randomly generated by the consumer P. A total consumption amount

$$S = {\sum }_{j = 1}^{n} {s}_{j}$$

is sent to a trusted node of the blockchain network via transfer of an account, Alipay and other transaction modes.

After the blockchain network receives the transaction uplinking application (PID∥C₁∥ . . . ∥Cₙ∥R₁∥ . . . ∥Rₙ∥S), the trusted node calculates a total commitment value Cⱼ′=

$${\prod }_{j = 1}^{n} {C}_{j} = {g}^{{\sum }_{j = 1}^{n} {r}_{j}} {h}^{{\sum }_{j = 1}^{n} {s}_{j}} = {h}^{S} .$$

If Cⱼ′ is not equal to Cⱼ, the transaction uplinking application is rejected. The total consumption amount S of the consumer P is returned. Otherwise, the agricultural product producer Apⱼ decrypts the transaction amount ciphertext Rⱼ using the private key Skjⱼ to obtain (rⱼ∥sⱼ)=D_{SK}_{ⱼ}(Rⱼ), where D_{SK}_{ⱼ}(·) is a private key decryption algorithm. It is verified if g^{r}^{ⱼ}h^{r}^{ⱼ} is equal to Cⱼ. If not, it means that the consumption amount sⱼ or the random number rⱼ given by the consumer P is incorrect, and the transaction uplinking application is rejected.

If it is verified that g^{r}^{ⱼ}h^{r}^{ⱼ} is equal to Cⱼ, the transaction uplinking application (PID∥C₁∥ . . . ∥Cₙ∥R₁∥ . . . ∥Rₙ∥S) passes the verification of the blockchain network. The blockchain network uplinks the transaction uplinking application (PID∥C₁∥ . . . ∥Cₙ∥R₁∥ . . . ∥Rₙ∥S) and generates the traceability code (IDⱼₖ∥FIDⱼₖ∥APⱼ), where FIDⱼₖ is a transaction number of the agricultural product of the agricultural product producer APⱼ. The traceability code is returned to the agricultural product producer APⱼ. The agricultural product producer Apjⱼ pastes the traceability code onto the agricultural product, and mails the agricultural product to the consumer P.

The agricultural product producer APⱼ sends (rⱼ∥sⱼ) to the trusted node via the safe channel. The trusted node Cⱼ′=g^{r}^{ⱼ}h^{r}^{ⱼ} calculates and verifies whether Cⱼ and Cⱼ are equal. If not, the error is returned. Otherwise, the trusted node sends the transaction amount sⱼ between the agricultural product producer APⱼ and the consumer P to the agricultural product producer APⱼ. To protect the rights of the consumer P and the agricultural product producer, the trading platform puts the transaction amount into the trusted node, and verifies and transfers the money only when a product producer proposes to want to withdraw the money in the trusted node.

Step 5, a phase of traceability of the agricultural product, verifying legitimacy of identities and data of the meta-universe visualization platform and the consumer, and then determining a permission to open up a traceability process of the meta-universe visualization platform for viewing based on verified results.

Once receiving the product, the consumer can scan the traceability code on the agricultural product to obtain basic information necessary for traceability, and propose a traceability application to the meta-universe visualization platform. Identity and data legitimacy verification is required between the meta-universe visualization platform and the consumer to ensure that the consumer is connected to a real meta-universe visualization platform and that the meta-universe visualization platform allows a legitimate consumer to access agricultural product-related information. Upon successful verification, the meta-universe visualization platform authorizes the consumer to access the growth process of the agricultural product, enabling the consumer's traceability on the product.

The consumer P scans the traceability code on the agricultural product to obtain (IDⱼₖ∥FIDⱼₖ∥APⱼ), selects one random number x as the temporary private key, calculates Y=gx, and calculates the shared key Key=(PKₘₑₜₐ)^{x}.

The generation mode of the shared key: Key₁=(PKₘₑₜₐ)^{x}=(g^{SK}^{ₘₑₜₐ})^{x}

$${Key}_{2} = {Y}^{{SK}_{meta}} = {( {g}^{x} )}^{{SK}_{meta}} = {( {g}^{{SK}_{meta}} )}^{x}$$

Obviously, Key₁=Key₂ and SKₘₑₜₐ is only mastered to be able to obtain the correct shared key Key, where PKₘₑₜₐ is the public key of the meta-universe visualization platform;

A traceability request TrackReq=(APⱼ∥rⱼ∥IDⱼₖ∥sⱼ)⊕H(Key∥TS₀) is calculated, where TS₀ is the current timestamp. The consumer P sends the traceability application (TrackReq∥X∥TS₀) to the meta-universe visualization platform.

After the meta-universe visualization platform receives the traceability application (TrackReq∥X∥TS₀), it is first checked whether the timestamp TS₀ is expired. If so, the traceability application is rejected. Otherwise, the shared key is calculated, where SKₘₑₜₐ is the private key of the meta-universe visualization platform. (APⱼ|∥rⱼ∥IDⱼₖ∥sⱼ)=TrackReq⊕H(Key∥TS₀) is obtained by calculation. Cⱼ′=g^{r}^{ⱼ}h^{r}^{ⱼ} is calculated. According to the APⱼ in the traceability code, the corresponding Cⱼ is taken out from the blockchain network and compared with Cⱼ′. If Cⱼ and Cⱼ′ are not equal, an error prompt of “basic information is filled in incorrectly” is returned to the consumer P. Otherwise, the agricultural product data Data corresponding to the IDⱼₖ is taken out from the cloud server using the IDⱼₖ as a key field. It should be noted here that in step 2, the root hₜ of the hash chain of the agricultural product data Dᵢ is stored into the blockchain network. The agricultural product data Dᵢ is stored into the cloud server. Because the agricultural product data Dᵢ taken out from the cloud server may be tampered, but the root hₜ of the hash chain in the blockchain network is never be tampered, in order to ensure the authenticity and completeness of the data, the agricultural product data Data taken out from the cloud server using IDⱼₖ are the data that are not tampered.

Then the meta-universe visualization platform calculates the signature σ=Sign(Skₘₑₜₐ,H(Data)) to calculate traceability information TrackMsg= (Data∥σ)⊕H(Key∥TS₁), where TS₁ is the current timestamp. Finally, the meta-universe visualization platform sends (TrackMsg∥TS₁) to the consumer P.

After the consumer P receives (TrackMsg∥TS₁), it is first checked whether the timestamp TS₁ is expired. If so, the traceability information TrackMsg is discarded. Otherwise, (Data∥σ) is deciphered using the shared key Key and TS₁ and the signature σ is verified using the public key Pkₘₑₜₐ. If verification fails, the agricultural product data Data are refused to receive. If the verification succeeds, the value hₜ of the hash chain is calculated using the agricultural product data Data. The value hₜ of the hash chain is inquired from the blockchain network. If the data are consistent, it is indicated that the traceability information is true and complete.

The forgoing are only specific embodiments of the present invention, but the protection scope of the present invention is not limited thereto. A person skilled in the art can easily think of changes or substitutions within the technical scope disclosed by the present invention, which should be covered within the protection scope of the present invention. Therefore, the protection scope of the present invention should be subject to the protection scope of the claims.

1. A method for tracing an agricultural product based on meta-universe, comprising the following steps:
Step 1, an initialization phase of a system, generating, by a trusted node, system parameters, and generating, by a trusted third party, a node secret key;
Step 2, an uplinking phase of data, collecting, by a terminal data collecting apparatus, agricultural product data in one period T, and generating an uplinking application; when a blockchain network receives the uplinking application, verifying legitimacy and authenticity of the uplinking application, and completing uplinking after it is verified that there is no error;
Step 3, a phase of growth of a virtual agricultural product and circulation of the agricultural product, verifying uplinked agricultural product data, triggering a growth function of the agricultural product in a smart contract using the agricultural product data after the verification is successful, a virtual agricultural product of a meta-universe visualization platform starting to grow, and updating a circulation trajectory of the agricultural product after the agricultural product grows to mature;
Step 4, a trading phase of the agricultural product, selling the agricultural product on a trading platform, generating, by the blockchain network, a traceability code after a consumer purchases the agricultural product successfully, pasting, by an agricultural product producer, the traceability code, and mailing the agricultural product to the consumer;
Step 5, a phase of traceability of the agricultural product, verifying legitimacy of identities and data of the meta-universe visualization platform and the consumer, and then determining a permission to open up a traceability process of the meta-universe visualization platform for viewing based on verified results.

2. The method for tracing the agricultural product based on the meta-universe according to claim 1, wherein the step 1 specifically comprises the following steps:
selecting, by the trusted node in the blockchain network, one q-order multiplicative cyclic group G, and two generators v and p of the multiplicative cyclic group G;
selecting, by the trusted node, one hash function H:{0,1}*→{0,1}¹, wherein 1 is the number of bits output by H, and H converts an input binary string with an arbitrary length into an output binary string with a fixed length;
selecting, by the trusted node, a public key encryption algorithm E_{PK}(·) and a private key decryption algorithm D_{SK}(·), wherein the public key encryption algorithm E_{PK}(·) is configured to generate a public key PK, and the private key decryption algorithm D_{SK}(·) is configured to generate a private key SK;
generating and publicizing, by the trusted node, the system parameters {G,q,v,p,H,E_{PK}(·),D_{SK}(·)}.

3. The method for tracing the agricultural product based on the meta-universe according to claim 1, wherein the step 2 specifically comprises the following steps:
collecting, by the terminal data collecting apparatus S_{f}, the agricultural product data in a period T, wherein f denotes a f-th terminal data collecting apparatus, f=1, 2, . . . , F, for collecting the agricultural product data from a j-th agricultural product producer APⱼ in the period T, j=1, 2, . . . , m, collecting t agricultural product data sequentially in the period T, which are D₁, D₂, . . . , Dₜ, generating roots of the t agricultural product data by a hash chain, uplinking a root of the hash chain, and letting an initial value ho of the hash chain be 0;
when the terminal data collecting apparatus S_{f} collects the agricultural product data Dᵢ, i=1, 2, . . . , t, calculating the corresponding hash chain hᵢ=H(hᵢ₋₁∥Dᵢ), and sending meta-information {Dᵢ,hᵢ} to a cloud server through a safe channel; when the period T is cut-off, obtaining, by the terminal data collecting apparatus S_{f}, the root hₜ of the hash chain;
if the agricultural product producer does not register a digitized identity in the blockchain network, sending, by the agricultural product producer APⱼ, a registered digitized identity application ReqInfo=(σⱼ∥PKⱼ∥CheckInfo∥TS) to the blockchain network, wherein CheckInfo is agricultural product related information, PKⱼ is a public key of the agricultural product producer APⱼ, SKⱼ is a private key of the agricultural product producer APⱼ, σⱼ is the signature of the agricultural product producer APⱼ on the registered digitized identity application ReqInfo using the private key SKⱼ, TS is a current timestamp, and ∥ is a connection character;
after receiving the registered digitized identity application ReqInfo, checking, by the blockchain network, freshness of the current timestamp TS, if TS is expired, rejecting, by the blockchain network, the registered digitized identity application ReqInfo; otherwise, verifying, by an issuing node, the signature σⱼ using the public key PKⱼ and checking CheckInfo information, after verification passes, applying, by the issuing node, a signature σⱼₖ to k-th agricultural product related information of the agricultural product producer Apⱼ, k=1, 2, . . . , K; mapping the registered digitized identity application ReqInfo as H (ReqInfo) using a hash function H, and using H (ReqInfo) as the digitized identity IDⱼₖ of the k-th agricultural product of the agricultural product producer APⱼ;
uploading, by the issuing node, the agricultural product digitized identity IDⱼₖ, the signature σⱼₖ, and CheckInfo information to the blockchain network, uplinking the agricultural product digitized identity IDⱼₖ through consensus of the blockchain network to obtain a blockchain network transaction number FIDⱼₖ; sending, by the issuing node, the agricultural product digitized identity IDⱼₖ, the signature σⱼₖ, and the blockchain network transaction number FIDⱼₖ to the agricultural product producer APⱼ;
calculating, by the terminal data collecting apparatus S_{f}, a signature σ_{f}=Sign(SK_{f}∥ID_{f}∥IDⱼₖ∥hₜ∥TS′), and sending the uplinking application (SK_{f}∥ID_{f}∥IDⱼₖ∥hₜ∥TS′∥σ_{f}) to the blockchain network, wherein ID_{f} is a digitized identity of the terminal data collecting apparatus S_{f}, the SK_{f} is a private key of the terminal data collecting apparatus S_{f}, and the TS′ is a current timestamp;
after receiving the uplinking application (SK_{f}∥ID_{f}∥IDⱼₖ∥hₜ∥TS′∥σ_{f}), checking, by the blockchain network, whether the timestamp TS' exceeds stipulated legal time; if so, rejecting uplinking application of the terminal data collecting apparatus S_{f}, otherwise, retrieving a public key certificate corresponding to ID_{f} from a blockchain node; if the public key certificate does not exist, rejecting the uplinking application of the terminal data collecting apparatus S_{f}, if the public key certificate exists, verifying, by the blockchain network, the signature σ_{f} using the public key PK_{f} in the public key certificate, PK_{f} being the public key of the terminal data collecting apparatus S_{f}; if the verification fails, rejecting the uplinking application of the terminal data collecting apparatus S_{f}; otherwise, uplinking, by the blockchain network, transaction information (ID_{f}∥IDⱼₖ∥hₜ∥TS′∥σ_{f}).

4. The method for tracing the agricultural product based on the meta-universe according to claim 3, wherein the step 3 specifically comprises the following steps:
after a root hₜ of a hash chain of the agricultural product data Dᵢ is successfully uplinked, sending, by the blockchain network, the digitized identity IDⱼₖ of the agricultural product to the meta-universe visualization platform, and obtaining, by the meta-universe visualization platform, the agricultural product data D₁, D₂, . . . , Dₜ and a value of the corresponding hash chain from the cloud server based on the digitized identity IDⱼₖ of the agricultural product;
after the meta-universe visualization platform receives the produce data Dᵢ from the cloud server, calculating the value hᵢ=H(hᵢ₋₁∥Dᵢ) of the hash chain, after calculating for t times, obtaining, by the meta-universe visualization platform, the root hₜ′ of the recalculated hash chain; removing, by the meta-universe visualization platform, the root hₜ of the originally uplinked hash chain from the blockchain network, if the hₜ′ is not equal to the hₜ, sending to the cloud server an error message that the data have an error, failing to verify the uplinked product data, and rejecting growth information of a virtual product for this time; otherwise, updating the growth information of a virtual product for this time;
after the uplinked product data is successfully verified, updating, by the meta-universe visualization platform, the current growing status of the virtual product using D₁, D₂, . . . , Dₜ.

5. The method for tracing the agricultural product based on the meta-universe according to claim 4, wherein the step 4 specifically comprises the following steps:
selecting and purchasing, by a consumer P, the agricultural product on a trading platform, if the consumer P purchases n agricultural products from the agricultural product producer, n≤m, randomly selecting the n random numbers satisfying
$${\sum }_{j = 1}^{n} {r}_{j} = 0$$
generate a commitment value of a purchase amount, rⱼ is the random number of the j-th agricultural product producer APⱼ; for the j-th agricultural product producer APⱼ, calculating, by the consumer P, the commitment value Cⱼ=g^{r}^{ⱼ}h^{r}^{ⱼ}, wherein sⱼ is a amount of money consumed by the consumer P in the agricultural product producer APⱼ, g^{r}^{ⱼ} is used to denote that the amount of money committed by the consumer P to consume for the agricultural product producer APⱼ is correct, and h^{r}^{ⱼ} is used to hide the amount sⱼ of money consumed by the consumer P for the agricultural product producer APⱼ;
encrypting, by the consumer P, rⱼ using the public key PKⱼ to obtain the transaction amount ciphertext Rⱼ=E_{PK}_{ⱼ}(rⱼ∥sⱼ), wherein E_{PK}_{ⱼ}(·) is a public key encryption algorithm, sending a transaction uplinking application (PID∥C₁∥ . . . ∥Cₙ∥R₁∥ . . . ∥Rₙ∥S) to the blockchain network, wherein PID is a dynamic pseudonym randomly generated by the consumer P, and sending a total consumption amount
$$S = {\sum }_{j = 1}^{n} {s}_{j}$$
to the trusted node or the blockchain network;
after the blockchain network receives the transaction uplinking application (PID∥C₁∥ . . . ∥Cₙ∥R₁∥ . . . ∥Rₙ∥S), calculating, by the trusted node, a total commitment value
$${C}_{j}^{′} = {\prod }_{j = 1}^{n} {C}_{j} = {g}^{{\sum }_{j = 1}^{n} {r}_{j}} {h}^{{\sum }_{j = 1}^{n} {s}_{j}} = {h}^{S} ,$$
if Cⱼ′ is not equal to Cⱼ, rejecting the transaction uplinking application and returning the total consumption amount S of the consumer P; otherwise, decrypting, by the agricultural product producer Apⱼ, the transaction amount ciphertext Rⱼ using the private key Skjⱼ to obtain (rⱼ∥sⱼ)=D_{SK}_{ⱼ}(Rⱼ), wherein D_{SK}_{ⱼ}(·) is a private key decryption algorithm, verifying if g^{r}^{ⱼ}h^{r}^{ⱼ} is equal to Cⱼ, if not, rejecting the transaction uplinking application;
if it is verified that g^{r}^{ⱼ}h^{r}^{ⱼ} is equal to Cⱼ, passing, by the transaction uplinking application (PID∥C₁∥ . . . ∥Cₙ∥R₁∥ . . . ∥Rₙ∥S), the verification of the blockchain network, uplinking, by the blockchain network, the transaction uplinking application (PID∥C₁∥ . . . ∥Cₙ∥R₁∥ . . . ∥Rₙ∥S) and generating the traceability code (IDⱼₖ∥FIDⱼₖ∥APⱼ), wherein FIDⱼₖ is a transaction number of the agricultural product of the agricultural product producer APⱼ, returning the traceability code to the agricultural product producer APⱼ; pasting, by the agricultural product producer APⱼ, the traceability code onto the agricultural product, and mailing the agricultural product to the consumer P;
sending, by the agricultural product producer APⱼ, (rⱼ∥sⱼ) to the trusted node via the safe channel, calculating, by the trusted node, C″=g^{r}^{ⱼ}h^{r}^{ⱼ} and verifying whether Cⱼ′ and Cⱼ are equal, if not, returning the error; otherwise, sending, by the trusted node, the transaction amount sⱼ between the agricultural product producer APⱼ and the consumer P, to the agricultural product producer APⱼ.

6. The method for tracing the agricultural product based on the meta-universe according to claim 5, wherein the step 5 specifically comprises the following steps:
scanning, by the consumer P, the traceability code on the agricultural product to obtain (IDⱼₖ∥FIDⱼₖ∥APⱼ), selecting the random number x as a temporary private key, calculating Y=g^{x}, calculating a shared key Key=(PKₘₑₜₐ)^{x}, wherein PKₘₑₜₐ is the public key of the meta-universe visualization platform; calculating the traceability request TrackReq=(APⱼ∥rⱼ∥IDⱼₖ∥sⱼ)⊕H(Key∥TS₀), wherein TS₀ is the current timestamp; and sending, by the consumer P, a traceability request (TrackReq∥X∥TS₀) to the meta-universe visualization platform;
after the meta-universe visualization platform receives the traceability application (TrackReq∥X∥TS₀), checking whether the timestamp TS₀ is expired, if so, rejecting the traceability application; otherwise, calculating the shared key, wherein SKₘₑₜₐ is the private key of the meta-universe visualization platform, obtaining (APⱼ|∥rⱼ∥IDⱼₖ∥sⱼ)=TrackReq⊕H(Key∥TS₀) by calculation, and calculating C′=g^{r}^{ⱼ}h^{r}^{ⱼ}; according to the APⱼ in the traceability code, taking out the corresponding Cⱼ from the blockchain network to be compared with the Cⱼ′, if Cⱼ and Cⱼ′ are not equal, returning to the consumer P an error prompt that basic information is filled in incorrectly; otherwise, taking IDⱼₖ as a key field, and taking out the product data Data corresponding to IDⱼₖ from the cloud server;
calculating, by the meta-universe visualization platform, the signature σ=Sign(Skₘₑₜₐ,H(Data)) to calculate the traceability information TrackMsg= (Data∥σ)⊕H(Key∥TS₁), wherein TS₁ is the current timestamp; and sending, by the meta-universe visualization platform, (TrackMsg∥TS₁) to the consumer P;
after the consumer P receives (TrackMsg∥TS₁), checking whether the timestamp TS₁ is expired, and if so, discarding traceability information TrackMsg; otherwise, deciphering (Data∥σ) using the shared key Key and TS₁, and verifying the signature σ using the public key PKₘₑₜₐ, if verification fails, refusing to receive the agricultural product data Data, if the verification is successful, calculating the value hₜ′ of the hash chain using the agricultural product data Data, and inquiring a value hₜ of the hash chain from the blockchain network, and indicating that the traceability information is true and complete if hₜ′ is equal to hₜ.
